(19) United States
(12) Patent Application Publication
(10) Pub. No.: US 2022/0036080 A1
(43) Pub. Date: Feb. 3, 2022

(54) SYSTEM AND METHOD FOR SYNCHRONOUSLY DISPLAYING CLOUD INFORMATION

(71) Applicants: China-Germany(Zhuhai) Artificial Intelligence Institute Co., Ltd, Zhuhai (CN); China-Germany Artificial Intelligence Institute Co., Ltd, Wuhu (CN); ZHUHAI 4DAGE TECHNOLOGY CO., LTD, Zhuhai (CN)

(72) Inventors: Yan CUI, Zhuhai (CN); Shiting XU, Zhuhai (CN)

(21) Appl. No.: 17/472,488

(22) Filed: Sep. 10, 2021

(30) Foreign Application Priority Data
Sep. 11, 2020 (CN) 202010955425.3

(51) Int. Cl. G06K 9/00; G06T 7/285

(52) U.S. Cl. CPC G06K 9/00697; G06K 9/00671; G06K 2209/21; G06T 2207/10028; G06T 7/285

(57) ABSTRACT

A system and method for synchronously displaying cloud information. The system includes a selection module configured for an individual to select a target scene; an initialization module configured to acquire a 3D scene of the target scene; an acquisition module configured to acquire an attribute information of the individual, a 3D scene information of the individual and a real-time motion information of the individual in the 3D scene by time or at the same time; an interaction module configured to perform interaction of information acquired by the acquisition module between different individuals; and a communication module configured to enable communication between different modules. The method includes: (S1) selecting a target scene by an individual; (S2) acquiring a 3D scene of the target scene; (S3) acquiring information by time or at the same time; and (S4) performing interaction of the acquired information between individuals.

### CROSS-REFERENCE TO RELATED APPLICATIONS

This application claims the benefit of priority from Chinese Patent Application No. 202010955425.3, filed on Sep. 11, 2020. The content of the aforementioned applications, including any intervening amendments thereto, is incorporated herein by reference in its entirety.

### TECHNICAL FIELD

The present application relates to computer technology, and more particularly to a system and method for synchronously displaying cloud information.

### BACKGROUND

In recent years, with the rapid development of cloud services, big data and artificial intelligence, as well as the increasing popularization of smart terminals, various cloud experience interaction methods, such as cloud house checking, cloud shopping, cloud expo (cloud exhibition) and cloud conference, have continuously emerged, which has significantly changed people's lifestyles. Combining with popular mini programs or APP (application), the offline domestic and international boutique expo, business and housing resource information are connected, blended and combined spatially with the online digital information resources, which achieves the extension of commodities or exhibits in time, space and content, such that the exhibition visit, shopping or house checking can be performed online and offline synchronously, and users are no longer restricted by region, timeliness and retention.

In the prior art, it is possible for an user to view various parts of a house as desired, and the user can also see other users who are viewing the house at the same time and know an area that others are interested in, so that the user can interact with others during the virtual three-dimensional house-checking process, augmenting the interactivity of the house-viewing process and making it more realistic.

Nevertheless, although the online house viewing and interaction with other users can be arrived at by means of the virtual 3D (three-dimensional) space, it cannot meet the real-time same-screen interaction or same-screen same-view angle among multiple users for the same scene, nor the real-time interaction among multiple users for different scenes.

### SUMMARY

An object of this application is to provide a system and method for synchronously displaying cloud information to overcome the defects in the prior art.

In a first aspect, this application provides a system for synchronously displaying cloud information, comprising:
a selection module;
an initialization module;
an acquisition module;
an interaction module; and
a communication module;
wherein the selection module is configured for an individual to select a target scene;
the initialization module is configured to acquire a three-dimension (3D) scene of the target scene;
the acquisition module is configured to acquire an attribute information of the individual, an information of the 3D scene and a real-time motion information of the individual in the 3D scene in the same time period or in different time periods;
the interaction module is configured to perform interaction of information acquired by the acquisition module between different individuals; and
the communication module is configured to enable communication among the selection module, the initialization module, the acquisition module and the interaction module.

In some embodiments, the interaction module comprises an event trigger unit, an initial position information interaction unit, a motion information interaction unit and a voice information interaction unit; and the event trigger unit is configured to start an interaction between different individuals.

In some embodiments, the initial position information interaction unit is configured to transmit the attribute information of the individual and/or the information of the 3D scene corresponding to the individual according to the attribute information of the individual by utilizing a communication technology.

In some embodiments, the motion information interaction unit is configured to transmit the real-time motion information of the individual in the 3D scene according to the attribute information of the individual by utilizing a communication technology.

In some embodiments, the voice information interaction unit is configured to enable a voice connection of the individual in the 3D scene by utilizing an information transmission technology.

In a second aspect, this application provides a method for synchronously displaying cloud information, comprising:
(S1) selecting a target scene by an individual;
(S2) acquiring a 3D scene of the target scene;
(S3) acquiring an information in different time periods or at the same time; and
(S4) performing interaction of the information acquired in step (S3) between individuals.

In some embodiments, the information acquired in step (S3) comprises an attribute information of the individual, an information of the 3D scene, and a real-time motion information of the individual in the 3D scene.

In some embodiments, in the step (S4), the step of “performing interaction of the information acquired in step (S3) between individuals” comprises:
transmitting the attribute information of the individual and/or the information of the 3D scene corresponding to the individual according to the attribute information of the individual by utilizing a communication technology; and
transmitting the real-time motion information according to the attribute information of the individual by utilizing the communication technology.

In some embodiments, in the step (S4), the step of “performing interaction of the information acquired in step (S3) between individuals” further comprises:
connecting different individuals in real time according to attribute information of different individuals by utilizing an information transmission technology.

Compared to the prior art, the application has the following beneficial effects.

This application enables the transmission of an attribute information of an individual, information of a 3D scene corresponding to the individual and a real-time motion information of the individual in the 3D scene according to an attribute information of the individual by utilizing a space communication technology, enabling the same-screen interaction of the different individuals during a cloud experience activity in different 3D scenes or the same 3D scene, and also enabling the same-screen and same-view angle interaction of different individuals during the cloud experience activity in the same 3D scene. Moreover, this application also achieves the voice connection and communication between different individuals in the 3D scene by utilizing a real-time communication technology.

### BRIEF DESCRIPTION OF THE DRAWINGS

The embodiments of this application will be described in detail below with reference to the accompanying drawings, and it should be understood that these embodiments are not intended to limit the scope of the disclosure.

Unless otherwise specified, terms “comprise”, “include” or variations thereof should be understood as including the mentioned elements or components, but not excluding other elements or other components.

FIG. 1 is a block diagram of a system for synchronously displaying cloud information according to an embodiment of the disclosure during the acquisition of information in the same time period;

FIG. 2 is a block diagram of the system according to an embodiment of the disclosure during the acquisition of information in different time periods;

FIG. 3 is a flow chart of a method of acquiring information in the same time period; and

FIG. 4 is a flow chart of a method of acquiring information in different time periods.

### DETAILED DESCRIPTION OF EMBODIMENTS

### Embodiment 1

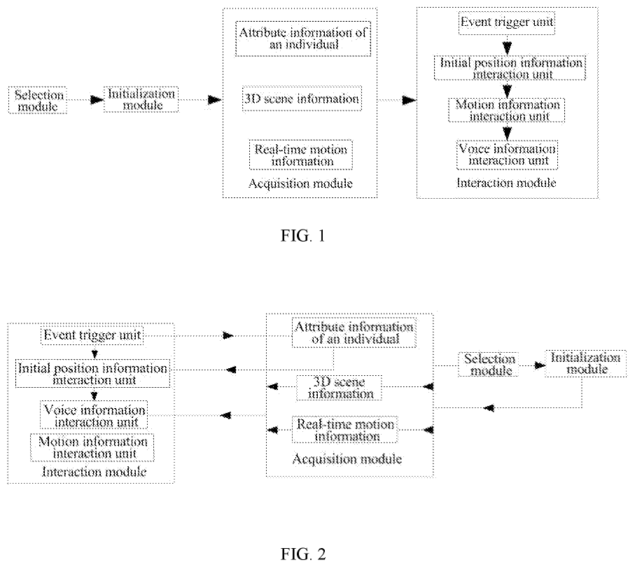

As shown in FIG. 1, this embodiment provides a system for synchronously displaying cloud information, which is applied to a real estate sales scene. There are usually two parts in real estate sales, where one is the viewing part and the other is the selling part. Each part usually includes multiple users, and in this embodiment, each part only includes one user. Specifically, a first user is regarded as the viewing part and a second user is regarded as the selling part. The system uses a software\program\applet\APP installed on a smart phone, pad or other smart devices as a carrier, and in this embodiment, the carrier is an APP installed on a smart phone. The system includes a selection module which is configured for the first user to select a target scene, and in this embodiment, the target scene is a house scene that the first user is interested in. When the first user operates this APP, the APP will provide a plurality of scenes (house scenes) for the first user to select such that the first user can select those of interest.

In this embodiment, after the first user selects a house scene of interest, an initialization module will automatically acquire a 3D scene information of the house of interest. Specifically, the automatic acquisition of the 3D scene information is to load the 3D scene, that is, to load a 3D model and a panorama of the 3D scene. There are no limitations for the method of building the 3D model and the panorama.

In this embodiment, an acquisition module automatically starts to acquire an attribute information of the first user, a 3D scene information and a real-time motion information of the first user in the 3D scene in the same time period while loading the 3D scene. In this embodiment, the attribute information of the first user is an ID information of the first user; the 3D scene information needs to be acquired separately for different 3D scenes (the 3D scene of this embodiment is the house, and thus the 3D scene information includes information of house type, story height and spatial point position); and the real-time motion information is information of a spatial point coordinate, movement angle\view angle, panorama\model switching and spatial point switching when the first user moves in the 3D scene. The real-time motion information of the first user in the 3D scene is acquired by moving a camera, and the information captured by the camera in the 3D scene is acquired via the acquisition module in different time periods or at the same time. In this embodiment, the real-time motion information of the first user in the 3D scene can be regarded as the real-time camera motion information.

In this embodiment, the system further includes an interaction module which is configured to perform interaction of the information acquired by the acquisition module between different individuals. Specifically, an event trigger unit in the interaction module is started by clicking a “Cloud leading” button, an “Online leading” button or a “Voice cloud leading” button arranged on the 3D scene interface of the house of interest. Then the APP starts an initial position information interaction unit in the interaction module to transmit the attribute information of the first user, (i.e., an ID information of the first user, and information of house type, story height and spatial point position when the first user initially enters the 3D scene) to the APP of the second user according to an attribute information of the second user (i.e., an ID information of the second user) by utilizing a communication technology, where the communication technology is preferably websocket; and the transmission is preferably performed using an uniform resource locator (URL). The APP of the first user transmits the URL to an instant messaging software of the second user, such as QQ, WeChat, DingTalk, etc. After receiving the URL on the instant messaging software, the second user clicks the URL containing the attribute information of the first user (i.e., the ID information of the first user) and the 3D scene information (i.e., the information of house type, story height and spatial point position), to enable the initial information interactive connection with the first user, so as to realize the same screen of the first user and the second user.

In this embodiment, the interaction module further includes a motion information interaction unit, which is configured to transmit the real-time motion information of the first user in the 3D scene (i.e., the information of spatial point coordinate, movement angle\view angle, panorama\model switching and spatial point switching) to a system of the second user according to the attribute information of the second user (i.e., the ID information of the second user) by utilizing the websocket. Based on the received real-time motion information of the first user, the second user adjusts a spatial motion information thereof (i.e., information of spatial motion real-time point coordinate, movement angle\view angle, panorama\model switching and spatial point switching of the second user) in real time. Meanwhile, when the second user is moving in space, the motion information interaction unit will transmit the real-time motion information of the second user in the 3D scene (i.e., the information of spatial point coordinate, movement angle\view angle, panorama\model switching and spatial point switching of the second user) to a system of the first user according to the attribute information of the first user (i.e., the ID information of the first user) by utilizing the websocket. Based on the real-time motion information of the second user, the first user adjusts the spatial motion information thereof (i.e., the information of spatial motion real-time point coordinate, movement angle\view angle, panorama\model switching and spatial point switching of the first user) in real time to always enable the same-screen and same-view angle interaction of the information captured by the camera when the first user and the second user are moving in the 3D scene.

In this embodiment, the interaction module further includes a spatial voice information interaction unit, which is configured to enable the voice connection between the first user and the second user in the 3D scene by means of the information transmission technology, where the information transmission technology is preferably the instant communication technology. The second user can have the voice connection with the first user after the first user enters the 3D scene of the house, that is, the selling part can lead the viewing part to synchronously visit the house, answer questions of the viewing part and provide a decision-making suggestion to the viewing part.

In this embodiment, when a first selling part introduces a house to a first user on line, a second selling part can synchronously show the same house to a second user on line. When the first selling part and the first user roam in the 3D space, their handheld terminal devices will not receive an interaction information, such as space roaming and voice interaction, between the second user and the second selling part, allowing individual users to independently view the same house on line.

In this embodiment, when the first selling part shows a house to the first user, the second user can enter the same house through the same URL. In this case, the first selling part simultaneously has the same-screen and same-view angle interaction with the first user and the second user, so that the first selling part can show the same house to different users. In this embodiment, the individuals who need to view the house synchronously are assigned to a room with real-time synchronous voice and basic information of the camera, where the basic information of the camera includes coordinate information, rotation angle information and status information. At this time, the room is taken as a unit, and all individuals in the room can share the real-time voice and the basic information captured by the camera. As a consequence, it can achieve not only the one-to-one synchronous display, but also the one-to-many synchronous display. Moreover, the voice and the 3D scene shoot by the camera can be shared in real time, achieving the same-screen and same-view angle interaction among multiple users.

### Embodiment 2

As shown in FIG. 1, this embodiment provides a system for synchronously displaying cloud information which is applied to a cloud experience in which multiple users visit the same store. The existing cloud experience is mostly independent cloud shopping, cloud exhibition visiting or cloud house viewing, so that the user cannot visit the same store, exhibition or house and have a real-time connection with his family and friends, leading to poor user experience. The cloud shopping is exemplarily described herein. In the cloud shopping, there are usually multiple users visiting the same store, and in this embodiment, there are two users, respectively a first user and a second user. This system uses a software\program\applet\APP installed on a smart phone, pad or other smart devices as a carrier, and in this embodiment, the carrier is an APP installed on a smart phone.

In addition to the application scene, this embodiment also has the following differences from Embodiment 1.

In this embodiment, the 3D scene information includes an attribute information of a store, product information, and spatial point position information.

In this embodiment, since the carrier is a software\program\applet\APP installed on a smart phone, pad or other smart devices, an interface of the software\program\applet\APP of the first user and the second user is split up and down or split left and right during the same-screen display.

In this embodiment, in order to ensure the real-time same-screen interaction between the first user and the second user during the cloud shopping, the interaction module further includes a motion information interaction unit. The motion information interaction unit is configured to transmit the real-time motion information of the first user in the 3D scene (i.e., information of spatial point coordinate, movement angle\view angle, panorama\model switching and spatial point position switching of the first user) to an APP of the second user according to an attribute information of the second user (i.e., an ID information of the second user,) by utilizing the communication technology. Meanwhile, the unit transmits the real-time motion information of the second user in the 3D scene (i.e., information of spatial point coordinate, movement angle\view angle, panorama\model switching and spatial point switching of the second user) to an APP of the first user according to an attribute information of the first user (i.e., an ID information of the first user) by utilizing the communication technology. In this embodiment, the communication technology is web socket to always enable the same-screen interaction of the first user and the second user when roaming in the 3D scene. The first user or the second user can select a desirable product on an interface of the APP and click an “Add to cart” button to add the product into a shopping cart, and pay on a platform or click a “Buy now” button to pay online. The first user or the second user can learn about the hot-selling products and discount information of the store by clicking an “Interactive” button above the corresponding product on the store interface or through the voice introduction of the second user.

### Embodiment 3

As shown in FIG. 2, this embodiment provides a system for synchronously displaying cloud information, which is applied to a cloud experience in which multiple users synchronously visit different exhibitions. The existing cloud experience is mostly independent cloud shopping, cloud exhibition visiting or cloud house viewing, so that the users cannot interact with other users, leading to poor user experience. In this embodiment, the cloud exhibition visiting is taken as an example for description. Generally, there are multiple users visiting the same exhibition in the cloud exhibition visiting, and in this embodiment, there are two users, respectively a first user and a second user. This system uses a software\program\applet\APP installed on a smart phone, pad or other smart devices as a carrier, and in this embodiment, the carrier is an APP installed on a smart phone. An interaction between the first user and the second user is started via an event trigger unit in the system when the first user opens the APP. Specifically, the event trigger unit is started by clicking a “Share” button on an interface of the APP. The acquisition module starts to acquire an attribute information of the first user (i.e., the ID information of the first user) when the event trigger unit is started.

In this embodiment, the system further includes an interaction module, which is configured to enable the interaction of the information acquired by the acquisition module between different individuals. The event trigger unit is started after the first user clicks the “Share” button, to start an initial position information interaction unit, so as to transmit the attribute information of the first user (i.e., an ID information of the first user) to a system of the second user according to an attribute information of the second user (i.e., an ID information of the second user) by utilizing a communication technology, where the communication technology is preferably the websocket; and the transmission is preferably performed by utilizing an uniform resource locator (URL). The first user transmits the URL to an instant messaging software of the second user, such as QQ, WeChat and DingTalk, and the second user receives the URL on the instant messaging software. Then the second user clicks the URL containing the attribute information of the first user (i.e., the ID information of the first user) to enable the same screen with the first user. Since the carrier is a software\program\applet\APP installed on a smart phone, pad or other smart devices, an interface of the software\program\applet\APP is split up and down or split left and right during the same-screen display. The interaction module further includes a spatial voice information interaction unit, which is configured to achieve the voice connection between the first user and the second user in the 3D scene by means of the information transmission technology, where the information transmission technology is preferably the instant message technology (IM) to arrive at the same-screen voice communication between the first user and the second user when visiting the exhibition of interest.

This system includes a selection module, which is configured for the first user to select a target scene. In this embodiment, the first user selects a target scene after completing the above steps, where the target scene is an exhibition scene of interest. The system will provide a variety of scenes (exhibition scenes) for the first user to select, and the first user can select an exhibition scene of interest.

In this embodiment, after the first user selects an exhibition scene of interest, the initialization module will automatically load a 3D scene of the exhibition of interest, and specifically, the 3D scene includes a 3D model and a panorama. There are no limitations for the method of building the 3D model and the panorama.

In this embodiment, the acquisition module is started to acquire a 3D scene information of the first user and a real-time motion information of the first user in the 3D scene while loading the 3D scene, that is, in this embodiment, the attribute information of the first user, the 3D scene information of the first user and the real-time motion information of the first user in the 3D scene are acquired respectively in different time periods. In this embodiment, the 3D scene information needs to be acquired separately for different 3D scenes, and specifically, the 3D scene of this embodiment is an exhibition, so that the 3D scene information includes exhibition attribute information, product information and spatial point position information. The real-time motion information herein is information of the spatial point coordinate, movement angle\view angle, panorama\model switching and spatial point switching when the first user moves in the 3D scene. The information acquisition manner is not particularly limited herein. Since the event trigger unit is started before the acquisition module works again, the 3D scene information acquisition of the acquisition module at this time is performed on the basis of the same screen of interfaces of APPs of the first user and the second user, such that the 3D scene acquired by the acquisition module will be automatically displayed on the same-screen interface.

In this embodiment, in order to ensure the real-time same-screen interaction between the first user and the second user during the cloud exhibition visiting, the interaction module further includes a motion information interaction unit, which is configured to transmit a real-time motion information of the first user in the 3D scene (i.e., information of the spatial point coordinate, movement angle\view angle, panorama\model switching and spatial point switching of the first user) to an APP of the second user according to an attribute information of the second user (i.e., an ID information of the second user) by utilizing the communication technology. Meanwhile, the unit transmits a real-time motion information of the second user in the 3D scene (i.e., information of spatial point coordinate, movement angle\view angle, panorama\model switching and spatial point switching of the second user) to an APP of the first user according to an attribute information of the first user (i.e., an ID information of the first user) by utilizing a communication technology, where the communication technology is preferably the websocket to enable the same-screen interaction between the first user and the second user when roaming in the 3D scene. The interaction module further includes a spatial voice information interaction unit, which is configured to enable the voice connection between the first user and the second user in the 3D scene by utilizing an information transmission technology, preferably an instant message technology (IM). By means of the information transmission technology, the voice communication and the same-screen interaction between the first user and the second user are achieved.

### Embodiment 4

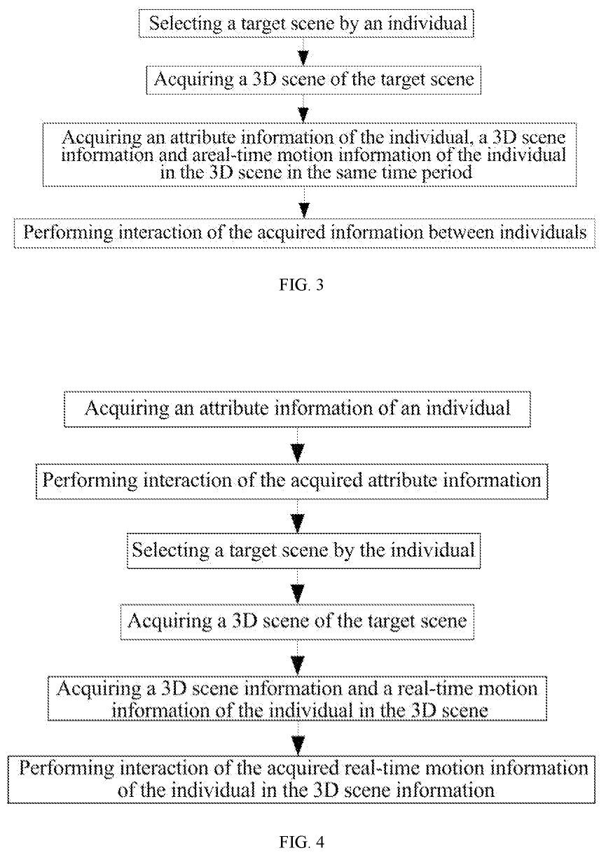

As shown in FIG. 3, this embodiment provides a method for synchronously displaying cloud information, which is applied to a real estate sales scene. There are usually two parts in real estate sales, where one is the viewing part and the other is the selling part. Each part usually includes multiple users, and in this embodiment, each part only includes one user. Specifically, a first user is regarded as the viewing part and a second user is regarded as the selling part. The method uses a software\program\applet\APP installed on a smart phone, pad or other smart devices as a carrier, and in this embodiment, the carrier is an APP installed on a smart phone. the first user opens the APP and selects a target scene, where the target scene is a house scene the first user interested in. When the first user operates this APP, the APP will provide multiple scenes (house scenes) for the first user to select. The first user can select those of interest and click to enter the house scene. The initialization module will automatically load a 3D scene of the exhibition of interest, and specifically, the 3D scene includes a 3D model and a panorama. There are no limitations for the method of building the 3D model and the panorama.

In this embodiment, after the first user selects a house of interest, the first user can share the 3D scene of the house to the second user by clicking a “Leading” button on the 3D scene interface of the house of interest. An attribute information of the first user, a 3D scene information and a real-time motion information of the first user in the 3D scene are acquired in the same time period while loading the 3D scene. In this embodiment, the attribute information of the first user is an ID information of the first user; the 3D scene information needs to be acquired separately for different 3D scenes (the 3D scene of this embodiment is the house, and thus the 3D scene information includes information of house type, story height and spatial point position); and the real-time motion information is information of a spatial point coordinate, movement angle\view angle, panorama\model switching and spatial point switching when the first user moves in the 3D scene. The real-time motion information of the first user in the 3D scene is acquired by moving a camera.

In this embodiment, after completing the above steps, an APP of the first user transmits the attribute information of the first user, (i.e., an ID information of the first user, and information of house type, story height and spatial point position when the first user initially enters the 3D scene) to an APP of the second user according to an attribute information of the second user (i.e., an ID information of the second user) by utilizing a communication technology, where the communication technology is preferably websocket; and the transmission is preferably performed using an uniform resource locator (URL). The APP of the first user transmits the URL to an instant messaging software of the second user, such as QQ, WeChat, DingTalk, etc. After receiving the URL on the instant messaging software, the second user clicks the URL containing the attribute information of the first user (i.e., the ID information of the first user) and the 3D scene information (i.e., the information of house type, story height and spatial point position) to realize a same screen of the first user and the second user. Meanwhile, a voice connection between the first user and the second user in the 3D scene is realized by utilizing an information transmission technology, preferably an instant message technology (IM). By means of the information transmission technology, the second user can have the voice connection with the first user after the first user enters the 3D scene of the house, that is, the selling part can lead the viewing part to synchronously visit the house to the viewing part.

In this embodiment, in order to ensure the same-screen and same-view angle interaction of the information captured by the camera when the first user and the second user are moving in the 3D scene, the APP of the first user transmits the real-time motion information of the first user in the 3D scene (i.e., the information of spatial point coordinate, movement angle\view angle, panorama\model switching and spatial point switching of the first user) to the APP of the second user according to the attribute information of the second user (i.e., the ID information of the second user) by utilizing the websocket. Based on the real-time motion information of the first user, the second user adjusts the spatial motion information thereof (i.e., the information of spatial motion real-time point coordinate, movement angle\view angle, panorama\model switching and spatial point switching of the second user) in real time.

### Embodiment 5

As shown in FIG. 3, this embodiment provides a method for synchronously displaying cloud information, which is applied to a cloud experience in which multiple users visit the same store. The existing cloud experience is mostly independent cloud shopping, cloud exhibition visiting or cloud house viewing, so that the user cannot visit the same store, exhibition or house and have a real-time connection with his family and friends, leading to poor user experience. The cloud shopping is exemplarily described herein. In the cloud shopping, there are usually multiple users visiting the same store, and in this embodiment, there are two users, respectively a first user and a second user. This system uses a software\program\applet\APP installed on a smart phone, pad or other smart devices as a carrier, and in this embodiment, the carrier is an APP installed on a smart phone. This embodiment has the following differences from Embodiment 3.

In this embodiment, the 3D scene of this embodiment is a store, so that the 3D scene information includes an attribute information of a store, product information, and spatial point position information.

In this embodiment, since the carrier is a software\program\applet\APP installed on a smart phone, pad or other smart devices, an interface of the software\program\applet\APP of the first user and the second user is split up and down or split left and right during the same-screen display.

In this embodiment, in order to ensure the real-time same-screen interaction between the first user and the second user during the cloud shopping, an APP of the first user transmits the real-time motion information of the first user in the 3D scene (i.e., information of spatial point coordinate, movement angle\view angle, panorama\model switching and spatial point position switching of the first user) to an APP of the second user according to an attribute information of the second user (i.e., an ID information of the second user,) by utilizing the communication technology. Meanwhile, the APP of the second user transmits the real-time motion information of the second user in the 3D scene (i.e., information of spatial point coordinate, movement angle\view angle, panorama\model switching and spatial point switching of the second user) to an APP of the first user according to an attribute information of the first user (i.e., an ID information of the first user) by utilizing the communication technology. In this embodiment, the communication technology is websocket to always enable the same-screen interaction of the first user and the second user when roaming in the 3D scene.

The first user or the second user can select a desirable product on an interface of a software\program\applet\APP and click an “Add to cart” button to add the product into a shopping cart, and pay on a platform or click a “Buy now” button to pay online. The first user or the second user can learn about the hot-selling products and discount information of the store by clicking an “Interactive” button above the corresponding product on the store interface or through the voice introduction of the second user.

### Embodiment 6

As shown in FIG. 4, this embodiment provides a method for synchronously displaying cloud information, which is applied to a cloud experience in which multiple users synchronously visit different exhibitions. The existing cloud experience is mostly independent cloud shopping, cloud exhibition visiting or cloud house viewing, so that the users cannot interact with other users, leading to poor user experience. In this embodiment, the cloud exhibition visiting is taken as an example for description. Generally, there are multiple users visiting the same exhibition in the cloud exhibition visiting, and in this embodiment, there are two users, respectively a first user and a second user. This system uses a software\program\applet\APP installed on a smart phone, pad or other smart devices as a carrier, and in this embodiment, the carrier is an APP installed on a smart phone. In this embodiment, the APP automatically acquire an attribute information of the first user (i.e., the ID information of the first user) when the first user opens the APP and clicks a “Share” button on an interface of the APP. The APP transmits the attribute information of the first user (i.e., an ID information of the first user) to an APP of the second user according to an attribute information of the second user (i.e., an ID information of the second user) by utilizing a communication technology, where the communication technology is preferably the websocket; and the transmission is preferably performed by utilizing an uniform resource locator (URL). The first user transmits the URL to an instant messaging software of the second user, such as QQ, WeChat and DingTalk, and the second user receives the URL on the instant messaging software. Then the second user clicks the URL containing the attribute information of the first user (i.e., the ID information of the first user) to enable the same screen with the first user. Since the carrier is an APP installed on a smart phone, an interface of the APP is split up and down or split left and right during the same-screen display. The voice connection between the first user and the second user in the 3D scene is achieved by means of the information transmission technology after achieving the same-screen, where the information transmission technology is preferably the instant message technology (IM) to arrive at the same-screen voice communication between the first user and the second user when visiting the exhibition of interest.

Since the same-screen voice communication has been achieved after the above steps, the first user and the second user can select a target scene on APPs of their smart phones respectively. In this embodiment, the target scene is an exhibition scene of interest. The APP will provide multiple scenes (exhibition scenes) for the users to select, and the users can select an exhibition scene of interest, thus the first user and the second user can select an exhibition scene of interest respectively.

In this embodiment, after the users select an exhibition scene of interest, the APP will automatically load a 3D scene of the exhibition of interest, and specifically, the 3D scene includes a 3D model and a panorama. There are no limitations for the method of building the 3D model and the panorama.

In this embodiment, the APP acquires a 3D scene information of the users and a real-time motion information of the users in the 3D scene while loading the 3D scene, that is, in this embodiment, the attribute information of the users, the 3D scene information of the users and the real-time motion information of the users in the 3D scene are acquired respectively in different time periods. In this embodiment, the 3D scene information needs to be acquired separately for different 3D scenes, and specifically, the 3D scene of this embodiment is an exhibition, so that the 3D scene information includes exhibition attribute information, product information and spatial point position information. The real-time motion information herein is information of the spatial point coordinate, movement angle\view angle, panorama\model switching and spatial point switching when the first user moves in the 3D scene. The real-time motion information is acquired by moving a camera. In this embodiment, the 3D scene information acquisition is performed on the basis of the same screen of interfaces of APPs of the first user and the second user, such that the 3D scene acquired by the acquisition module will be automatically displayed on the same-screen interface.

In this embodiment, in order to ensure the real-time same-screen interaction between the first user and the second user during the cloud exhibition visiting, the APP of the first user transmits a real-time motion information of the first user in the 3D scene (i.e., information of the spatial point coordinate, movement angle\view angle, panorama\model switching and spatial point switching of the first user) to the APP of the second user according to an attribute information of the second user (i.e., an ID information of the second user) by utilizing the communication technology. Meanwhile, the APP of the second user transmits a real-time motion information of the second user in the 3D scene (i.e., information of spatial point coordinate, movement angle\view angle, panorama\model switching and spatial point switching of the second user) to the APP of the first user according to an attribute information of the first user (i.e., an ID information of the first user) by utilizing a communication technology, where the communication technology is preferably the websocket to enable the same-screen interaction between the first user and the second user when roaming in the 3D scene.

### Embodiment 7

The 3D models mentioned in the above Embodiments 1-6 are all established using an artificial intelligence-structure from motion (AI-SFM), and in this embodiment, the establishment of a 3D scene of a house using the AI-SFM algorithm is exemplarily described as follows.

(S1) A house of a certain type is divided into a plurality of areas, and an image acquisition module is arranged in each area to acquire and store multiple sets of images. In this embodiment, the image acquisition module includes at least one set of dome camera and one set of depth camera.

(S2) The 3D modeling is carried out for each area separately to obtain a 3D model of each area.

In the present application, the 3D model of each area is built through the establishment of an AI (artificial intelligence) 3D depth estimation model combined with a SFM (structure from motion)-based camera pose optimization algorithm, which is specifically described as follows:

(S21) The image acquisition module is calibrated and the multiple sets of images are preprocessed.

A self-calibration model of the dome camera is built to calibrate an intrinsic parameter and an extrinsic parameter, such that an optimal camera pose parameter is obtained, and the calibration process can be optimized by BA (bundle adjustment). The de-distortion of the images is completed based on distortion coefficients of the intrinsic parameter and extrinsic parameter of the camera and a deformation model.

(S22) The preprocessed images are input into the 3D depth estimation model for training.

a. The dome camera and the depth camera are fixedly arranged at the same position in the space, and at least one 2D (two-dimensional) image including the 2D information is acquired by the dome camera, and at least one 3D image including the 3D information is acquired by the depth camera.

b. The acquired 2D images and the corresponding 3D images are transmitted into the AI 3D depth estimation model for multiple training until a network converges, such that the model can output a depth information corresponding to the 2D image.

(S23) The 3D depth estimation model is optimized by utilizing a loss function.

In the present application, the AI 3D depth estimation model is trained using a fully convolutional neural network, and an effective residual upsampling module for tacking a high-dimensional regression problem is included. During the training of the AI 3D depth estimation model, as the number of network layers increases, gradient disappearance (explosion) will occur, which causes the network to fail to converge. Therefore, a residual learning module ResNET50 is added into an input layer of the fully convolutional neural network and initialized using a weight of the pre-training. The residual learning module ResNET50 is connected with a convolutional layer and a pooling layer.

(S24) The 3D model of each area is built based on the combination of the 3D depth estimation model and the camera pose optimization algorithm, which is specifically described as follows.

(S241) Generation of a dense point cloud corresponding to a first area using the AI 3D depth estimation model

Multiple sets of images of the first area in the multiple areas captured by an image acquisition device are transmitted to the AI 3D depth estimation model for training, and a dense point cloud corresponding to the first area is output.

(S242) Calculation of a precise pose of the camera and distribution of different spatial point clouds

The camera is accurately located using the SFM algorithm, and the dense point clouds are subjected to matching comparison using an ICP (iterative closest point) algorithm to place the point clouds belonging to different spaces in different positions.

(S243) Labeling of dense point cloud

The dense point clouds are denoised using distance and reprojection methods, and labeled.

(S244) Generation of visible space using dense point clouds

A visible space is built through the intertwining of a plurality of virtual straight lines, where a starting point of the virtual straight line is a dense point cloud and an end point is a corresponding dome camera. The space enclosed by the lines is cut out.

(S245) Establishment of the 3D model of the first area in the house scene

A closed space is built on a basis of the shortest path method of graph theory, and a 2D panoramic photo taken by a dome camera at a certain position in the space is attached to a corresponding position on the 3D model, such that the 3D modeling of the first area in the house scene is completed.

(S246) The above steps are repeated to complete the 3D modeling for the multiple areas of the house, such that the 3D models of the areas are built, and finally the 3D model of the house is built.

It should be noted that in the step S242, it is required to optimize the camera pose using the BA during the location of the camera position using the SFM.

Described above are merely preferred embodiments of the disclosure, which are illustrative and are not intended to limit the disclosure. It should be understood that any variations, modifications and replacements made by those skilled in the art without departing from the spirit of the disclosure should fall within the scope of the disclosure defined by the appended claims.

What is claimed is:

1. A system for synchronously displaying cloud information, comprising:
a selection module;
an initialization module;
an acquisition module;
an interaction module; and
a communication module;
wherein the selection module is configured for an individual to select a target scene;
the initialization module is configured to acquire a three-dimension (3D) scene of the target scene;
the acquisition module is configured to acquire an attribute information of the individual, an information of the 3D scene and a real-time motion information of the individual in the 3D scene in the same time period or in different time periods;
the interaction module is configured to perform interaction of information acquired by the acquisition module between different individuals; and
the communication module is configured to enable communication among the selection module, the initialization module, the acquisition module and the interaction module.

2. The system of claim 1, wherein the interaction module comprises an event trigger unit, an initial position information interaction unit, a motion information interaction unit and a voice information interaction unit; and the event trigger unit is configured to start an interaction between different individuals.

3. The system of claim 2, wherein the initial position information interaction unit is configured to transmit the attribute information of the individual and/or the information of the 3D scene corresponding to the individual according to the attribute information of the individual by utilizing a communication technology.

4. The system of claim 2, wherein the motion information interaction unit is configured to transmit the real-time motion information of the individual in the 3D scene according to the attribute information of the individual by utilizing a communication technology.

5. The system of claim 3, wherein the voice information interaction unit is configured to enable a voice connection of the individual in the 3D scene by utilizing an information transmission technology.

6. The system of claim 4, wherein the voice information interaction unit is configured to enable a voice connection of the individual in the 3D scene by utilizing an information transmission technology.

7. A method for synchronously displaying cloud information, comprising:
(S1) selecting a target scene by an individual;
(S2) acquiring a 3D scene of the target scene;
(S3) acquiring an information in different time periods or at the same time; and
(S4) performing interaction of the information acquired in step (S3) between individuals.

8. The method of claim 7, wherein the information acquired in step (S3) comprises an attribute information of the individual, an information of the 3D scene, and a real-time motion information of the individual in the 3D scene.

9. The method of claim 8, wherein in the step (S4), the step of “performing interaction of the information acquired in step (S3) between individuals” comprises:
transmitting the attribute information of the individual and/or the information of the 3D scene corresponding to the individual according to the attribute information of the individual by utilizing a communication technology; and
transmitting the real-time motion information according to the attribute information of the individual by utilizing the communication technology.

10. The method of claim 9, wherein in the step (S4), the step of “performing interaction of the information acquired in step (S3) between individuals” further comprises:
connecting different individuals in real time according to attribute information of different individuals by utilizing an information transmission technology.
